(19) United States
(12) Patent Application Publication
(10) Pub. No.: US 2025/0210664 A1
(43) Pub. Date: Jun. 26, 2025

(54) POWDEROUS RUBBERS WITH LITHIUM STEARATE, AND USE THEREOF AS AN ELECTRODE BINDER

(71) Applicant: ARLANXEO DEUTSCHLAND GMBH, Dormagen (DE)

(72) Inventors: Sven BRANDAU, Leverkusen (DE); Susanna LIEBER, Kaiserslautern (DE)

(73) Assignee: ARLANXEO DEUTSCHLAND GMBH, (US)

(21) Appl. No.: 18/850,181

(22) PCT Filed: May 19, 2023
(86) PCT No.: PCT/EP2023/063502

§ 371 Date: Sep. 24, 2024

(30) Foreign Application Priority Data
May 27, 2022 (EP) 22175839.4

(51) Int. Cl. H01M 4/62; H01M 4/02; H01M 4/505; H01M 4/525; H01M 10/0525

(52) U.S. Cl. CPC H01M 4/622; H01M 4/505; H01M 4/525; H01M 4/625; H01M 10/0525; H01M 2004/028

(57) ABSTRACT

Powderous rubbers with lithium salts as antidusting agents and methods of using the powderous rubbers as a binder in battery applications are disclosed.

This application is a 371 of PCT/EP2023/063502, filed May 19, 2023, which claims priority benefit under 35 U.S.C. § 119 of the EP 22175839.4, filed May 27, 2022, the disclosures of which are incorporated herein by reference.

The present invention relates generally to a binder of an electrode composition for a cathode of a cell of a lithium-ion battery, a cathode slurry composition comprising the electrode composition, a cathode, a process for manufacturing this cathode, and a lithium-ion battery having one or more cells incorporating this cathode. In particular, the present invention relates to powderous rubbers with Lithium salts as antidusting agents and use thereof as a binder in battery applications.

### TECHNICAL FIELD

Lithium-ion batteries consist of at least two conductive Coulombic electrodes of different polarities, the negative electrode or anode (generally made of graphite) and the positive electrode or cathode, between which electrodes a separator is located, which separator consists of an electrical insulator imbibed with an aprotic electrolyte based on Li⁺ ion cations ensuring the ionic conductivity. The electrolytes used in these lithium-ion batteries typically consist of a lithium salt, for example LiPF₆, LiAsF₆, LiCF₃SO₃ or LiCO₄, which is dissolved in a mixture of non-aqueous solvents such as acetonitrile, tetrahydrofuran, or more often a carbonate, for example of ethylene carbonate, ethyl methyl carbonate dimethyl carbonate, vinylene carbonate or propylene carbonate. The active material of the cathode of a lithium-ion battery allows reversible insertion/removal of lithium ions into/from this cathode, and the higher the mass fraction of this active material in the cathode, the higher its capacity. The cathode must also contain an electrically conductive compound, such as carbon black and, in order to provide it with sufficient mechanical cohesion, a polymer binder, which is required as well for a good adhesion to the collector foil. The binder must therefore interact with both the active material and the electrical conductor, while maintaining electrochemical stability and high flexibility. A lithium-ion battery is thus based on the reversible exchange of lithium ions between the anode and the cathode during the charging and discharging of the battery, and, for a very low weight, by virtue of the physical properties of lithium, such a battery has a high energy density.

The cathodes of lithium-ion batteries are often manufactured using a process comprising, in succession, a step of dissolving and/or dispersing the polymer binder, the active material, the conductive material and optionally a dispersant, in a solvent, a step of applying the obtained cathode slurry composition on a current collector, and then lastly a step of evaporating this solvent.

The polymer binder is dispersed in the cathode slurry composition to improve adherence between the cathode active material and adhesion of the cathode active material with the current collector. Simultaneously the polymer binder assists the dispersion of the conductive material. The electrolyte holding ability of the polymer binder improves battery characteristics.

During the charging-discharging process the lithium ions are loaded and unloaded into the active material. Due to this movement of lithium ions expansion and dilation of the cathode and anode material can occur. It is therefore highly desirable to use elastomeric materials as binder, for lithium-ion batteries, to enable flexible movement of the active material during use without delamination from the current collector or crack formation. Unfortunately highly crystalline binders might be too stiff to enable movement and a rubber type binder will be preferred.

The polymer binder is an important part of the electrode and used to help disperse the active material and conductive material in the cathode slurry composition, to stabilize these materials in the slurry during the cathode preparation and enable smooth cathodes with well-defined pore structure. During use, the cohesion of the cathode and its adhesion with the current collector is of vital importance and influenced strongly by the type, and the respective functional moieties of the polymer, of binder used. Adhesion and cohesion is a key property of the polymer binder which determines the final performance of the lithium-ion batteries, especially in the long term. A good polymer binder guarantees the homogeneous dispersion of active material and conductive material together with stable bonding to the metallic collector.

Many types of polymer binders can be used, nevertheless a gradual changeover from conventional electrodes using fluorinated polymers, based on PVDF (polyvinylidene fluoride), which is easily compatible with a cathode operating at a high operating voltage and is available in powderous form, or mixtures of PVDF with various other polymer binders, as e.g. carboxymethylcellulose (CMC), styrene butadiene rubber (SBR), hydrogenated nitrile rubbers (HNBR) or polyacrylic acid (PAA), is taking place. PVDF is the most widely used polymer binder in lithium-ion batteries as it exhibits electrochemical stability, bonding strength and low thermal degradation. Due to its high crystallinity levels, PVDF offers high resistance in typical electrolytes used in lithium-ion batteries. However, the low flexibility of PVDF might not meet the demands for cathode due to breaking of the bonds between the cathode active material and the conductive material when flexible electrodes are required or when the durable expansion/contraction process of the cathode active material occurs during cycling as well when higher adhesion forces are required to reduce total binder amounts in the cathode. Other fluorine-free polymer binders such as HNBR are yet not available in any powderous form to enable an easier processing for batteries.

Moreover the occasional occurrences of battery fires have caused some concern especially regarding the risk for spontaneous fires and the intense heat generated by such fires. While the fire itself and the heat it generates may be a serious threat in many situations, the risks associated with gas and smoke emissions from malfunctioning lithium-ion batteries may in some circumstances be a larger threat, especially in confined environments where people are present, such as in an aircraft, a submarine, a mine shaft, a spacecraft or in a home equipped with a battery energy storage system. At elevated temperatures the parts of the battery such as the polyvinylidene fluoride (PVDF) binder in the electrodes, may form toxic gases such as hydrogen fluoride (HF).

A lot of research was also focused on the cathode active material optimizations to enhance the electrochemical properties of lithium-ion batteries, while less attention was devoted yet in the past to the advancement of the electrically inactive components of the cathode, such as the polymer binder. However, a recent trend was to develop novel electrode compositions based on typical cathode active materials to substitute the fluor containing polymer binders, such as PVDF, with polymer binders with good adhesion and cohesion as well as high capacity retention to obtain a long lifetime of the battery.

EP 3 283 538 relates to pulverulent mixtures containing at least one nitrile rubber and at least one separating agent which are characterized by a specified mean particle diameter. Said mixtures have a particularly low emission level and are extremely suitable for the production of materials and components for indoor applications. The pulverant mixtures with the low emission levels are obtained by using a specific molecular weight modifier. Different antidusting agents are summarized in the invention, nevertheless, the use of any Lithium containing salt is not mentioned, neither the use of the powderous rubbers in any battery application.

EP 3 902 855 relates to powdery mixtures based on special pre-crosslinked nitrile rubbers and at least one release agent, further a method for producing vulcanizable mixtures as well as vulcanizates from these powdery mixtures and the same obtained vulcanizates and their use, especially in tire treads. By using a specific trifunctional acrylate crosslinker in the polymerization of nitrile rubbers, powderous rubbers can be prepared out of those, using standard antidusting agents as silica or Ca salts. When using those powderous nitrile rubbers as additive in tire treads, the wet grip of the tires can be improved. Different antidusting agents are summarized in the invention, the use of any Lithium containing salt is not mentioned, neither the use of those powderous rubbers in any battery application.

EP 3 900 086 relates to an electrode composition for a cathode of a cell of a lithium-ion battery comprising an epoxy group-containing fluorine-free copolymer, a cathode slurry composition comprising the electrode composition, a cathode, a process for manufacturing this cathode, and a lithium-ion battery having one or more cells incorporating this cathode. The epoxy group-containing fluorine-free copolymers are either NBR or EVM polymers. The transformation of those rubbers into powders or the use of powderous rubbers in battery application is not described.

However, no adequate powderous polymer binder has been identified so far that is applicable to Li-containing cathode active materials to provide electrode compositions for a cathode of a cell of a lithium-ion battery which are suitable for battery applications and still show improvements versus standard PVDF binders.

Therefore, one aim of the present invention is to provide an electrode composition for cathodes for lithium-ion batteries that overcomes some or all of the aforementioned drawbacks.

It is an object of the invention to provide electrode compositions that can be used to provide cathodes having improved properties compared to cathodes comprising standard PVDF binders.

Surprisingly, it was found that Lithium stearate as antidusting agent for elastomers is leading to free-flowing powderous rubbers which additionally show a good processing for electrodes and a fast dissolution in typical battery solvents. Moreover, the used antidusting agent can work as sacrificial anode leading to an improved battery performance.

Through screening and evaluation of different antidusting agents and their use in the preparation of powderous polymer binders, Lithium salts were surprisingly identified as new antidusting agents for battery applications. By using those Lithium salts as new antidusting agents, free flowing polymer powders could be obtained and in battery application tests a higher adhesion forces of the cathode sheets were maintained for different polymer powders in comparison to standard PVDF binders. Moreover, discharging specific capacity attenuation was improved towards non inventive polymer powders or even to nonpowderous rubber samples. It is assumed that the added Lithium salts can serve as sacrificial anode in the battery leading to a better capacity retention.

### INVENTION

The object of the invention has been achieved by providing a pulverulent mixture of elastomers comprising
(1) (a) an ethylene-vinyl acetate copolymer (EVA) containing repeat units
   of an ethylene monomer, and
   of a vinyl acetate monomer in an amount of at least 70% by weight and based on the total weight of the ethylene-vinyl acetate copolymer;
or
(b) a nitrile rubber copolymer (NBR) which is optionally carboxylated (XNBR) and contains repeat units
   of an α,β-unsaturated nitrile monomer selected from the group consisting of acrylonitrile, methacrylonitrile, ethacrylonitrile and mixtures thereof, preferably in each case in an amount of at least 15% by weight and based on the total weight of the nitrile rubber copolymer, and
   of a conjugated diene monomer which is optionally fully or partially hydrogenated (HNBR) and is selected from the group consisting of 1,2-butadiene, 1,3-butadiene, isoprene, 2,3-dimethylbutadiene, piperylene and mixtures thereof;
and
(2) an antidusting agent comprising lithium stearate.

In the context of the present invention, the terms “pulverulent” and “powderous”, preferably “free-flowing powderous”, can be used as synonyms.

In the context of the present invention, the terms “antidusting agent” and “separating agent” can be used as synonyms and refer to the pulverulent mixture to and avoid agglomeration of the individual elastomer particles.

Preferably, the pulverulent mixture has a particle size distribution D90 of at least 100 μm, more preferably 200 μm to 750 μm, as determined by using a laser diffuser and using the Fraunhofer approximation.

Preferably, the pulverulent mixture is fluorine-free.

Preferably, the nitrile rubber copolymer (b) is a carboxylated nitrile rubber (XNBR).

Preferably, the ethylene-vinyl acetate copolymer (a) or the nitrile rubber copolymer (b) has a Mooney viscosity (ML(1+4) 100° C.) of ≥25 Mooney units (MU), more preferably of 28 Mooney units (MU) to 120 Mooney units (MU), determined by means of a shearing disc viscometer to DIN 53523/3 or ASTM D 1646 at 100° C.

Preferably, the Lithium stearate is present in an amount of at least 3% by weight, more preferably 3% by weight to 60% by weight, still more preferably 5% by weight to 40% by weight, yet more preferably 5% by weight to 20% by weight, in each case based on the total weight of the pulverulent mixture.

Preferably the Lithium stearate serves as antidusting agent.

Preferably, the pulverulent mixture does not contain an antidusting agent except for Lithium stearate.

In another preferred embodiment, however, the pulverulent mixture contains at least one antidusting agent in addition to Lithium stearate.

Appropriate copolymers and Lithium stearate are available to the skilled person. For example, appropriate copolymers are provided under the trade names of Levapren® 900, Therban® XT, Therban® AT LT2004VP, Therban® LT1707VP, Therban® 3407, Nanoprene® M20VP, Therban® 4307, Perbunan® 3945, Nanoprene® M20VP and Krynac® X 146. Likewise, methods for producing and determining appropriate copolymers are available to the skilled person as well (see, e.g., EP 3 283 538, EP 3 902 855 and EP 3 900 086).

The term “copolymer” encompasses polymers having more than one monomer unit. In one embodiment of the invention, the respective copolymer is derived exclusively, for example, from the monomer types as described above. The term “copolymer” likewise encompasses, for example, additionally ter- or quaterpolymers, derived from the monomer types as described above and at least one further monomer unit.

The monomers are preferably distributed statistically over the polymer chain of the copolymer used in accordance with the invention.

A fully hydrogenated nitrile rubber copolymer (b) preferably comprises less than 1% residual doublebonds of the fully unsatured copolymer (b). A partially hydrogenated nitrile rubber copolymer (b) preferably comprises 1% or more residual doublebonds of the fully unsatured copolymer (b).

In a second aspect, the invention relates to a cathode slurry composition comprising the pulverulent mixture according to the invention, at least one cathode active material, at least one conductive material, and at least one solvent.

In a third aspect, the invention relates to a cathode comprising a current collector and a cathode active material layer, wherein the cathode active material layer comprises the pulverulent mixture according to the invention and the conductive material.

In a fourth aspect, the invention relates to a lithium-ion battery comprising at least one cell comprising an anode, a cathode according to the invention, a separator and an electrolytic solution based on a lithium salt and on an organic solvent.

Preferably, the peel strength of the cathode sheet of the lithium-ion battery is at least 340 N/m, preferably measured in accordance with the experimental section of the present application.

In a fifth aspect, the invention relates to the use of the pulverulent mixture according to the invention as a binder in an electrode composition for a cathode of a cell of a battery.

### DETAILED DESCRIPTION

### Further Monomer Units

Copolymers (a), (b) and (c) may contain at least one further monomer unit in addition to the monomer units as described above. Exemplary further monomer units are defined in the following.

Preferred examples of additional epoxy group-containing monomers are selected from the group consisting of 2-ethylglycidyl acrylate, 2-ethylglycidyl methacrylate, 2-(n-propyl)glycidyl acrylate, 2-(n-propyl)glycidyl methacrylate, 2-(n-butyl)glycidyl acrylate, 2-(n-butyl)glycidyl methacrylate, glycidylmethyl acrylate, glycidylmethyl methacrylate, glycidyl acrylate, glycidyl methacrylate, (3′,4′-epoxyheptyl)-2-ethyl acrylate, (3′,4′-epoxyheptyl)-2-ethyl methacrylate, 6′,7′-epoxyheptyl acrylate, 6′,7′-epoxyheptyl methacrylate, allyl glycidyl ether, allyl 3,4-epoxyheptyl ether, 6,7-epoxyheptyl allyl ether, vinyl glycidyl ether, vinyl 3,4-epoxyheptyl ether, 3,4-epoxyheptyl vinyl ether, 6,7-epoxyheptyl vinyl ether, o-vinylbenzyl glycidyl ether, m-vinylbenzyl glycidyl ether, p-vinylbenzyl glycidyl ether and 3-vinylcyclohexene oxide.

Most preferably, the epoxy group-containing monomer is a glycidyl (alkyl)acrylate, preferably glycidyl acrylate and/or glycidyl methacrylate.

Moreover, the copolymer used according to the invention may additionally comprise repeating units of one or more further copolymerizable monomers known in the art, e.g. α,β-unsaturated (preferably mono-unsaturated) monocarboxylic acids, their esters and amides, α,β-unsaturated (preferably mono-unsaturated) dicarboxylic acids, their mono- or diesters, as well as the respective anhydrides or amides of said α,β-unsaturated dicarboxylic acids, vinyl esters, vinyl ketones, vinyl aromatic compounds, α-monoolefins, vinyl monomers having a hydroxyl group, and carbon monoxide.

As α,β-unsaturated monocarboxylic acids, preference is given to using acrylic acid and methacrylic acid.

It is also possible to use esters of α,β-unsaturated monocarboxylic acids, preferably the alkyl esters and alkoxyalkyl esters thereof. Preference is given to the alkyl esters, in particular C₁-C₁₈-alkyl esters, of α,β-unsaturated monocarboxylic acids. Particular preference is given to alkyl esters, in particular C₁-C₁₈-alkyl esters, of acrylic acid or of methacrylic acid, in particular methyl acrylate, ethyl acrylate, propyl acrylate, n-butyl acrylate, tert-butyl acrylate, 2-ethylhexyl acrylate, n-dodecyl acrylate, methyl methacrylate, ethyl methacrylate, butyl methacrylate and 2-ethylhexyl methacrylate. Preference is also given to alkoxyalkyl esters of α,β-unsaturated monocarboxylic acids, particularly preferably alkoxyalkyl esters of acrylic acid or of methacrylic acid, in particular C₂-C₁₄-alkoxyalkyl esters of acrylic acid or of methacrylic acid, very particularly preferably preferably methoxymethyl (meth)acrylate, methoxyethyl (meth)acrylate, ethoxyethyl (meth)acrylate, butoxyethyl (meth)acrylate and methoxyethoxyethyl (meth)acrylate; butoxydiethylenglycol methacrylate, polyethylene glycol acrylates and polyethylene glycol methacrylates. It is also possible to use mixtures of alkyl esters such as those mentioned above with alkoxyalkyl esters, e.g. in the form of those mentioned above. It is also possible to use hydroxylalkyl acrylates and hydroxyalkyl methacrylate in which the number of carbon atoms in the hydroxyalkyl groups is 1-12; preferably 2-hydroxyethyl acetylate, 2-hydroxyethyl methacrylate and 3-hydroxypropyl acrylate; it is also possible to use α,β-unsaturated carboxylic esters containing amino groups, e.g. dimethylaminomethyl acrylate, N-(2-hydroxyethyl)acrylamide, N-(2-hydroxymethyl)acrylamide, urethane (meth)acrylate and diethylaminoethyl acrylate.

It is also possible to use α,β-unsaturated dicarboxylic acids, preferably maleic acid, fumaric acid, crotonic acid, itaconic acid, citraconic acid and measaconic acid, as further copolymerizable monomers.

α,β-Unsaturated dicarboxylic anhydrides, preferably maleic anhydride, itaconic anhydride, citraconic anhydride and mesaconic anhydride, can also be used.

Monoesters or diesters of α,β-unsaturated dicarboxylic acids can also be used. These α,β-unsaturated dicarboxlic monoesters or diesters can be, for example, alkyl, preferably C₁-C₁₀-alkyl, in particular ethyl, n-propyl, isopropyl, n-butyl, tert-butyl, n-pentyl or n-hexyl, monoesters or diesters, alkoxyalkyl, preferably C₂-C₁₂-alkoxyalkyl, particularly preferably C₃-C₈-alkoxyalkyl, monoesters or diesters, hydroxyalkyl, preferably C₁-C₁₂-hydroxyalkyl, particularly preferably C₃-C₈-hydroxyalkyl, monoesters or diesters, cycloalkyl, preferably C₅-C₁₂-cycloalkyl, particularly preferably C₆-C₁₂-cycloalkyl, monoesters or diesters, alkylcycloalkyl, preferably C₆-C₁₂-alkylcycloalkyl, particularly preferably C₇-C₁₀-alkylcycloalkyl, monoesters or diesters, aryl, preferably C₆-C₁₄-aryl, monoesters or diesters, with the diesters in each case also being able to be mixed esters.

As α,β-unsaturated dicarboxylic diesters, it is possible to use the analogous diesters based on the abovementioned monoester groups, with the ester groups also being able to be chemically different ester groups.

As vinyl esters it is possible to use, for example, vinyl propionate and vinyl butyrate.

As vinyl ketones it is possible to use, for example, methyl vinyl ketone and ethyl vinyl ketone.

As vinyl aromatic compounds it is possible to use, for example, styrene, α-methylstyrene and vinyltoluene.

As α-monoolefins it is possible to use, for example, C₂-C₁₂-olefins as for example, propylene, 1-butene, 4-butene, 4-methyl-1-pentene, 1-hexene and 1-octene.

Possible further copolymerizable monomers are also free-radically polymerizable compounds which contain at least two olefinic double bonds per molecule. Such monomers accordingly lead to a certain degree of precrosslinking of the copolymer (a), (b) or (c). Examples of multiply unsaturated compounds are acrylates, methacrylates, or itaconates of polyols, e.g. ethylene glycol diacrylate, diethylene glycol dimethacrylate, triethylene glycol diacrylate, 1,4-butanediol diacrylate, 1,2-propanediol diacrylate, 1,3-butanediol dimethacrylate, neopentyl glycol diacrylate, trimethylolpropane di(meth)acrylate, trimethylolethane di(meth)acrylate, trimethylolpropane tri(meth)acrylate, glycerol diacrylate and triacrylate, pentaerythritol di-, tri- and tetraacrylate or di-, tri- and tetramethacrylate, dipentaerythritol tetra-, penta- and hexaacrylate or tetra-, penta- and hexamethacrylate or tetra-, penta- and hexaitaconate, sorbitol tetraacrylate, sorbital hexamethacrylate, diacrylates or dimethacrylates of 1,4-cyclohexanediol, 1,4-dimethylolcyclohexane, 2,2-bis(4-hydroxyphenyl)propane, of polyethylene glycols or of oligoesters or oligourethanes having terminal hydroxyl groups. As multiply unsaturated monomers, it is also possible to use acrylamides such as methylenebisacrylamide, hexamethylene-1,6-bisacrylamide, diethylenetriamine trismethacrylamide, bis(methacrylamido-propoxy)ethane or 2-acrylamidoethyl acrylate. Examples of multiply unsaturated vinyl and allyl compounds are divinylbenzene, ethylene glycol divinyl ether, diallyl phthalate, allyl methacrylate, diallyl maleate, triallyl isocyanurate or triallyl phosphate.

Acetoacetoxyethyl methacrylate is another example of a preferred additional monomer.

The total proportion of further copolymerizable monomers incorporated is less than 35% by weight, preferably less than 25% by weight, particularly preferably less than 20% by weight and especially preferably less than 15% by weight, based on the copolymer (a), (b) or (c). The total content monomers and the optionally used further monomers mentioned above adds up to 100% by weight, based on the copolymer (a), (b) or (c).

### Cathode Active Material

The cathode active material according to the invention is preferably selected from the group of lithium-containing metal oxides, including, optionally layered, lithium-containing metal oxides such as LiCoO₂, LiNiO₂, LiMn₂O₄ or LiNiMnCoO₂, lithium manganese oxides such as LiMnO₃, LiMn₂O₃, LiMnO₂ and the like, lithium nickel manganese cobalt oxides such as Li_{w}NiₓMn_{y}Co_{z}O₂ and the like, lithium nickel cobalt aluminum oxides such as LiNiCoAlO₂ and the like, or even modified nickel manganese cobalt oxides such as Li₁₊ₐNiₓMn_{z}Co_{y}M_{w}O₂ wherein, M may be at least one selected from the group consisting of aluminum (Al), copper (Cu), iron (Fe), vanadium (V), chromium (Cr), titanium (Ti), zirconium (Zr), zinc (Zn), tantalum (Ta), niobium (Nb), magnesium (Mg), boron (B), tungsten (W), and molybdenum (Mo), and a, x, y, z, and w represent an atomic fraction of each independent element, wherein −0.5≤a≤0.5, 0<x≤1, 0<y≤1, 0≤z≤1, 0≤w≤1, and 0<x+y+z≤1, lithium titanate such as Li₄Ti₅O₁₂ and the like, lithium copper oxides such as Li₂CuO₂, vanadium oxides such as LiV₃O₈, LiFe₃O₄, or phosphates such as LiCoPO₄, or LiFePO₄, that accepts and donates electrons in the cathode.

In a preferred embodiment, the at least one cathode active material comprises a compound of the following Formula 1:

Li₁₊ₐNiₓCo_{y}Mn_{z}M_{w}O₂ [Formula 1]

wherein, M may be at least one selected from the group consisting of aluminum (Al), copper (Cu), iron (Fe), vanadium (V), chromium (Cr), titanium (Ti), zirconium (Zr), zinc (Zn), tantalum (Ta), niobium (Nb), magnesium (Mg), boron (B), tungsten (W), and molybdenum (Mo), and a, x, y, z, and w represent an atomic fraction of each independent element, wherein −0.5≤a≤0.5, 0<x≤1, 0<y≤1, 0≤z≤1, 0≤w≤1, and 0<x+y+z≤1 or lithium iron phosphates (LFP).

In another preferred embodiment, the cathode active material may comprise a nickel excess lithium composite metal oxide in which −0.5≤a≤0.5, 0<x<1, 0<y<1, 0<z<1, 0≤w≤1, and y+z≤x in Formula 1.

In another preferred embodiment, the cathode active material may comprise LiNi_{0.3}Mn_{0.3}Co_{0.3}O₂, LiNi_{0.6}Mn_{0.2}Co_{0.2}O₂, LiNi_{0.5}Mn_{0.3}CO_{0.2}O₂, LiNi_{0.7}Mn_{0.15}CO_{0.15}O₂, or LiNi_{0.8}Mn_{0.1}Co_{0.01}O₂, and any one thereof or a mixture of two or more thereof may be used.

Particularly preferred cathode active materials according to invention are lithium-nickel-cobalt-manganese-oxide (NMC), lithium iron phosphates (LFP) or lithium-nickel-cobalt-aluminum-oxide (NCA). Particularly preferred is lithium-nickel-cobalt-manganese-oxide (NMC).

### Conductive Material

The cathode slurry composition comprises at least one electrically conductive material (in the following named as “conductive material”). Preferred conductive materials are selected from the group consisting of carbon black, acetylene black, Ketjen black, channel black, furnace black, lamp black and summer black, natural and artificial graphite, expanded graphite, conductive fibers such as carbon fiber and metal fiber, metal powders such as carbon fluoride, aluminum and nickel powder, and carbon nanotube, graphene, graphene oxide and their mixtures. By comprising the conductive material, the electrical connection of the cathode active materials can be improved, and the discharge rate characteristic can be improved.

In a preferred embodiment, the conductive material is present in the cathode slurry composition in an amount of 0.5 to 50% by weight based on the total solid weight of the cathode slurry composition.

### Solvent

The cathode slurry composition comprises at least one solvent. The solvent is not particularly limited as long as the binder according to the invention can be (partially) dispersed or dissolved uniformly, and water or organic solvent can be used. The organic solvent may comprise cyclic aliphatic hydrocarbons such as cyclopentane and cyclohexane; aromatic hydrocarbons such as chlorobenzene, toluene, xylene and cyclobenzene; ketones such as acetone, methyl ethyl ketone, diisopropyl ketone, cyclohexanone, methylcyclohexane, ethylcyclohexane; chlorine based aliphatic hydrocarbons such as methylene chloride, chloroform, and carbon tetrachloride; esters such as ethyl acetate, butyl acetate, α-butyrolactone, ε-caprolactone; acylonitriles such as acetonitrile or propionitrile; ethers such as tetrahydrofurane or ethyleneglycoldiethylether; alcohols such as tert-butanol, glycerol, methanol, ethanol, isopropanol, ethyleneglycol, triethyleneglycol or ethyleneglycolmonomethylether; sulfones such as diethyl sulfone, ethyl methyl sulfone or tetramethylene sulfone, nitriles such as malononitrile or succinonitril, amides such as N-methylpyrrolidone (NMP), N-formylmorpholine and N,N-dimethylformamide may be mentioned. Preferred solvents are methyl ethyl ketone, toluene and N-methylpyrrolidone. Particularly preferred is N-methylpyrrolidone.

### Method for Producing the Cathode Slurry Composition

The production method of the cathode slurry composition used in the present invention is not particularly limited, and it is produced by mixing the binder according to the invention with the cathode active material, the conductive material and optionally further additives. Alternatively but not limiting the binder according to the invention is mixed first with cathode active material, the conductive material and optionally further additives before the solvent is added.

The mixing device is not particularly limited as long as the binder solution, the cathode active material and the conductive material can be mixed uniformly; and for example the method of using the mixing device such as the stirring type, the shaking type, and the rotating type may be mentioned. Also, the method using the dispersing kneader such as homogenizer, ball mill, sand mill, roll mill, a planetary kneader such as planetary mixer or an extruder may be mentioned.

### Cathode (Positive Electrode)

The cathode of the secondary battery of the present invention comprises a current collector, and a cathode active material layer. The cathode active material layer comprises the inventive electrode composition, the conductive material and optionally other components which are added depending on the needs may be comprised as well. The cathode active material layer is formed on said current collector.

### Current Collector

The current collector is not particularly limited if this is a material having electric conductivity and electrochemical durability. Preferably, in view of the heat resistance, the current collector is selected from a group consisting of iron, copper, aluminum, nickel, sintered carbon, stainless steel, stainless steel treated with carbon, titanium, tantalum, gold, platinum, titanium or silver on the surface thereof; an aluminum-cadmium alloy, a non-conductive polymer treated with a conductive material on the surface thereof; a conductive polymer or a metal paste comprising metal powders of Ni, Al, Au, Ag, Pd, Cr, Ta, Cu or Ba. Among these, aluminum is particularly preferable for current collector of cathode. The current collector may be formed in various forms such as a film, a sheet, a foil, a net, a porous body, a foam or a nonwoven fabric. The shape of the current collector is not particularly limited, and the sheet form current collector having a thickness of about 0.001 to 0.5 mm is preferable, more preferable 3 to 500 μm. It is preferable that the current collector is subject to a roughening treatment in advance before the use, in order to increase the adhering strength with the cathode active material layer. Method of the roughening treatment may include mechanical polishing method, electropolishing method, chemical polishing method, etc. In the mechanical polishing cathode, a coated abrasive cathode in which abrasive particles are fixed, a grinding stone, an emery buff or a wire-brush provided with steel wire can be used. Also, an intermediate or primer coating layer may be formed on the surface of the current collector to increase the adhering strength and conductivity between the cathode active material layer and the current collector.

### Process for Manufacturing a Cathode

The invention further relates to a process for manufacturing a cathode such as defined above, characterized in that it comprises the following steps of
(1) dissolving the binder according to the invention in a solvent to form a binder solution; and
(2) mixing the binder solution from step (1) with the cathode active material, a conductive material and optionally further additives to form a cathode slurry composition,
(3) applying the cathode slurry composition from step (2) onto a current collector to form a cathode sheet; and
(4) drying the cathode sheet of step (3).

In an alternative embodiment, the binder according to the invention, the cathode active material, a conductive material and optionally further additives of step (1) and (2) are mixed first before a solvent is added. In a preferred embodiment the binder according to the invention is dissolved first in a solvent according to step (1).

In a preferred embodiment of this invention, but not limiting, step (1) may be carried out by dissolving the binder according to the invention in a shaker over night at room temperature. In a preferred embodiment of this invention, the binder solution formed in step (1) has a concentration of 0.1 to 30% by weight, preferably 0.25 to 20% by weight and more preferably 0.5 to 15% by weight based on the total weight of the binder solution.

In a preferred embodiment of this invention, but not limiting, step (2) may be carried out in a ball mill including dry ball-milling, wet ball-milling planetary ball milling or a tumble mixer.

In a preferred embodiment of this invention, but not limiting, step (3) may be carried out with a bar coater or doctor blade more preferably with a bar coater with a slit gap of 50 to 750 μm.

In a preferred embodiment of this invention, step (4) may be carried out in an oven, more preferably at a temperature of 50° C. to 200° C., even more preferably 50° C. to 150° C.

In a preferred embodiment, but not limiting, the cathode sheet is calendered to adjust the areal density after the drying step (4).

The cathodes are punched from the calandered cathode sheet.

### Lithium-Ion Battery

The invention further relates to a lithium-ion battery comprising one or more cell comprising the cathode of this invention. A lithium-ion battery according to the invention comprises at least one cell comprising an anode, a cathode such as defined above, a separator and an electrolytic solution based on a lithium salt and on an organic solvent.

### Electrolytic Solution

As the electrolytic solution for the lithium-ion battery, an organic electrolytic solution can be used wherein the supporting electrolyte is dissolved in an organic solvent.

As the supporting electrolyte, a lithium salt may be used. The lithium salt is not particularly limited, and for example, LiNO₃, LiCl, LiBr, LiI, LiPF₆, LiAsF₆, LiBF₄, LiSbF₆, LiAlCl₄, LiClO₄, CF₃SO₃Li, C₄F₉SO₃Li, CF₃COOLi, (CF₃CO)₂NLi, (CF₃SO₂)₂NLi, (C₂F₅SO₂)NLi, lithium chloroborate, lithium tetraphenylborate and the like may be used. Among these, LiPF₆, LiClO₄, CF₃SO₃Li are preferable since these are easily dissolved in the organic solvent and show a high degree of dissociation. Two or more thereof can be used together. If the supporting electrolytes have a higher dissociation degree, the lithium-ion conductivity becomes higher, thus the lithium-ion conductivity can be regulated by the type of the supporting electrolyte.

The organic solvent used for the electrolytic solution for the lithium-ion battery is not particularly limited as long as the supporting electrolytes can be dissolved. Carbonates such as dimethyl carbonate (DMC), ethylene carbonate (EC), diethyl carbonate (DEC), propylene carbonate (PC), butylene carbonate (BC), fluoroethylene carbonate (FEC) or methyl ethyl carbonate (MEC); esters such as α-butyrolactone or methyl formate; ethers such as 1,2-dimethoxy ethane and tetrahydrofuran; sulfur-containing compounds such as sulfolane and dimethyl sulfoxide may or used. The mixed solvent thereof may be used as well. Among these, the carbonates are preferable as it has high dielectric constant, and the stable electric potential is wide. The lower the viscosity of the used solvent is, the higher the lithium-ion conductivity is; thus the lithium-ion conductivity can be regulated by the type of the solvent.

Further additives can be added to the electrolytic solution. Carbonates such as vinylene carbonate (VC) are preferable as additive.

For the purpose of improving the charge/discharge characteristics and the flame retardancy, the electrolytic solution may contain at least one additive selected from the group consisting of pyridine, triethylphosphite, triethanolamine, cyclic ether, ethylenediamine, diglyme, benzene derivatives, sulfur, N-substituted oxazolidinones, N,N-substituted imidazolidines, ethylene glycol dialkyl ethers, ammonium salts, pyrrole or 2-methoxyethanol.

The concentration of the supporting electrolyte in the electrolytic solution for the lithium-ion battery is typically 0.01 to 30% by weight, preferably 0.05 to 20% by weight, particularly preferably 0.1 to 15% by weight based on the total weight of the electrolytic solution. The ion conductivity tends to decline in case the concentration of the supporting electrolyte is too low or too high.

### Separator

As separator for the lithium-ion battery known separators such as fine porous films or nonwoven fabrics comprising aromatic polyamide resins or the polyolefin based polymers, such as polyethylene or polypropylene; may be used. For example, the fine porous film formed by the resin such as polyolefin type polymer (polyethylene, polypropylene, polybutene, ethylene-butene copolymers, ethylene-hexene copolymers, ethylene-methacrylate copolymers and polyvinyl chloride) and the mixture or the copolymer thereof; the fine porous film consisting of polyethylene terephthalate, polyesters, polyacetals, polyamides, polycarbonates, polyether ether ketones, polyether sulfones, polyphenylene oxides, polyphenylene sulfides polycycloolefin, polyether sulfone, polyamide, polyimide, polyimideamide, polyaramid, polycycloolefin, nylon or polytetrafuluoro ethylene, the woven fabric wherein the polyolefin type fiber are woven or the non-woven fabric thereof, and the aggregate of the insulating material particles may be mentioned. The separator may consist as well of a porous substrate made of a mixture of inorganic particles and a polymer; or a separator having a porous coating layer formed on at least one surface of the porous polymersubstrate and comprising inorganic particles and a binder polymer. Among these, the fine porous film formed by the polyolefin type polymers is preferable since the thickness of the separator as a whole can be made thinner and the capacity per volume can be increased by increasing the active material ratio in the battery.

The thickness of the separator is typically 0.01 to 300 μm, preferably 1 to 100 μm, and more preferably 1 to 40 μm. When it is within this range, the resistance of the separator in the battery becomes smaller, and the processing while forming the battery is superior.

In some cases, a gel polymer electrolyte may be coated on the separator to increase the stability of the cell. Representative examples of such a gel polymer include polyethylene oxide, polyvinylidene fluoride, and polyacrylonitrile.

### Anode (Negative Electrode)

The anode active material layer selectively comprise a binder and a conductive agent in addition to the anode active material. The anode active material layer may be prepared by coating a composition for forming an anode, which selectively comprises the binder and the conductive agent as well as the anode active material, on the negative electrode collector and drying the coated anode collector, or may be prepared by casting the composition for forming an anode on a separate support and then laminating a film separated from the support on the anode collector. As the current collector, those mentioned in the cathode of the lithium-ion battery can be mentioned, and it is not particularly limited as long as it is a material having the electric conductivity and the electrochemical durability; however copper is preferable as the anode of the lithium-ion battery.

### Anode Active Material

As the anode active material for the lithium-ion battery anode, for example carbon materials such as amorphous carbon, natural graphite, artificial graphite, natural black lead, mesocarbon microbead and pitch-based carbon fiber, conductive polymer such as polyacene or polyaniline may be mentioned. Also, as the anode active material, a metal such as silicon, tin, zinc, manganese, iron and nickel, the alloy thereof, oxide and sulfate salt of the above metal or alloy can be used. In addition, metals including Si, Na, Al, Sn, Li, Zn, Mg, Cd, Ce, Ni and Fe, alloys of the metals; oxides of the metals such as LiCoO₂, LiNiO₂, LiMn₂O₄, MnO₂, FeO₂, V₂O₅, TiO₂, LiₓNi_{0.5}Mn_{1.5}O₄, LiₓMn_{0.5}Ni_{0.5}O₂, metal hydroxides, metal sulfides such as LiVS₂, LiTiS₂, VS₂ or TiS₂, phosphates of the metals such as LiCoPO₄, Li₃V₂PO₄, LiTi₂(PO₄)₃, LiFePO₄, thiophosphates such as LiTi₂(PS₄)₃, composites of the metals and carbon materials as mentioned above; and a mixture thereof, lithium, lithium alloy such as LiC₆, Li₁₃Sn₅, Li₉Al₄, Li₂₂Si₅, or nitride of lithium-transition metal can be used as well. As the anode active material, those adhered with the conductivity supplying material on the surface by the surface mechanical modified method can be used as well.

The content ratio of the anode active material of the anode active material layer is preferably 85 to 99.9% by weight, and more preferably 90 to 99.75% by weight based on the total weight of the anode active material layer. If for the anode active material metals such as Si, Na, Al, Sn, Li, Zn, Mg, Cd, Ce, Ni or Fe are used, the content can be up to 100%. By having the content ratio of the anode active material within said range, it can exhibit flexibility and the binding property while showing high capacity.

Also, in the anode for the lithium-ion battery, besides the above mentioned component, the solvent used in the cathode of aforementioned, or the electrolytic solution additives which has function to suppress the electrolytic solution decomposition may be included. These may not be particularly limited, as long as it does not influence the battery reaction.

### Anode Binder

As the binder for the lithium-ion battery anode, known material can be used without any particular limitation. Examples for such binders for the lithium-ion battery include polyethylene, polytetrafluoroethylene (PTFE), polyvinylidene fluoride (PVDF), tetrafluoroethylene-hexafluoropropylene copolymer (FEP), polyacrylic acid, polyvinyl alcohol, carboxymethylcellulose (CMC), starch, lignin, hydroxypropylcellulose, regenerated cellulose, polyvinylpyrrolidone, polyvinyl alcohol, polyamide imide, polypropylene, ethylene-propylene-diene polymer (EPDM), sulfonated EPDM, styrene butadiene rubber, nitrile rubber, fluorine rubber derivative or polyacrylonitrile derivative; soft polymers such as acrylic based soft polymer. These may be used alone or by combining two or more thereof.

The negative electrode for the lithium-ion battery can be produced as same as the aforementioned positive electrode.

### Process for Producing a Lithium-Ion Battery

As the specific production method of the lithium-ion battery, the cathode and the anode mentioned in above may be layered via the separator, which is then winded or bended depending on the battery shape to fit in the battery case, followed by filling the electrolyte in the battery case and sealing the case. Also, as needed, it is possible to prevent pressure increase inside the battery and overcharge-overdischarge by setting in expanded metal such as a nickel sponge, overcurrent protection element such as fuse and PTC element, and lead plate, etc. The shape of the battery may include coin shape, button shape, sheet shape, cylinder shape, square shape and flattened shape.

The present invention is demonstrated by the following non-limiting Examples.

The following materials were used:

| Materials | Abbreviation/Trade name & Source |
|---|---|
| Levapren ® 900 | Polymer A, Ethylene-vinyl acetate copolymer, typical |
| | properties: vinyl acetate content 90 wt.-%; Mooney viscosity |
| | ML(1 + 4) 100° C. = 38 MU |
| Therban ® XT | Polymer B, Partially hydrogenated carboxylated butadiene |
| | acrylonitrile terpolymer, typical properties: ACN content 33.0 |
| | wt.-%; Mooney viscosity ML(1 + 4) 100° C. = 77 MU. |
| Acetoacetoxyalkyl | Polymer C, Fully hydrogenated butadiene acrylonitrile |
| methacrylate -containing | terpolymer, typical properties: ACN content 39.3 wt.-%; |
| hydrogenated acrylonitrile | Mooney viscosity ML(1 + 4) 100° C. = 72 MU |
| butadiene copolymer | |
| Therban ® AT LT2004VP | Polymer D, Fully hydrogenated butadiene acrylonitrile |
| | terpolymer, typical properties: ACN content 21.0 wt.-%; |
| | Mooney viscosity ML(1 + 4) 100° C. = 74 MU |
| Therban ® LT1707VP | Polymer E, Fully hydrogenated butadiene acrylonitrile |
| | terpolymer, typical properties: ACN content 17.0 wt.-%; |
| | Mooney viscosity ML(1 + 4) 100° C. = 70 MU |
| Therban ® 3407 | Polymer F, Fully hydrogenated butadiene acrylonitrile |
| | copolymer, typical properties: ACN content 34.0 wt.-%; |
| | Mooney viscosity ML(1 + 4) 100° C. = 70 MU |
| Nanoprene ® M20VP | Polymer G, Hydroxyl group-containing polymer gel, glass |
| | transition temperature of −20° C. |
| Therban ® 4307 | Polymer H, Fully hydrogenated butadiene acrylonitrile |
| | copolymer, typical properties: ACN content 43.0 wt.-%; |
| | Mooney viscosity ML(1 + 4) 100° C. = 63 MU |
| Perbunan ® 3945 | Polymer I, Butadiene acrylonitrile copolymer, typical |
| | properties: ACN content 39.0 wt.-%; Mooney viscosity |
| | ML(1 + 4) 100° C. = 45 MU |
| Nanoprene ® M75VP | Polymer J, Hydroxyl group-containing polymer gel, glass |
| | transition temperature of −75° C. |
| Krynac ® X 146 | Polymer K, Carboxylated butadiene acrylonitrile terpolymer, |
| | typical properties: ACN content 32.5 wt.-%; Mooney viscosity |
| | ML(1 + 4) 100° C. = 45 MU |
| Krynar ® HSV 900 | Polymer L, fluorinated thermoplastic homopolymers from |
| | ARKEMA |

| Materials antidusting | |
|---|---|
| agents | Abbreviation/Trade name & Source |
| Lithium stearate | Antidusting agent, Lithium stearate, CAS number 4485-12-5 |
| Calcium stearate | Antidusting agent, Calcium stearate, CAS number 68424-16-8 |
| Calcium carbonate | Antidusting agent, Calcium carbonate, CAS number 471-34-1 |
| Silica | Antidusting agent, Sipernat ® 22S, Evonik Resource Efficiency |
| | GmbH |
| Lithium carbonate | Antidusting agent, Lithium carbonate, CAS number 554-13-2 |
| Lithium phosphate | Antidusting agent, Lithium phosphate, CAS number 10377-52-3 |
| Aluminium oxide | Antidusting agent, AEROXIDE ® Alu C 805, Evonik Resource |
| | Efficiency GmbH |

| Materials battery | Abbreviation/Trade name & Source |
|---|---|
| Lithium-nickel-cobalt- | Active material; NMC (3/3/3 type 8.0 to 13.0 μm; Jining |
| manganese-oxide | WuJie Sci. Tech Co., Ltd |
| Conductive carbon black | Conductive material; Super P; TIMCAL company |
| Aluminum foil | Current collector; Thickness 20 μm; China Aluminum Shanxi |
| | New Material Co. |
| N-methyl pyrrolidone | Solvent; 99.9% battery grade; Shandong YunChangXin |
| (NMP) | Chemical Tech. Co. |
| Lithium disc | Anode; ø 16 mm; China Energy Lithium Co., Ltd |
| Porous polyolefin film | Separator; Celgard 2340, thickness 38 μm, punched into ø |
| | 18 mm disc; Celgard |
| LiPF₆ | Electrolytic solution: 1M in EC/DEC mixture, |
| | EC/DEC = 50/50 (v/v); Aldrich |
| Ethylene carbonate (EC) | Organic solvent used for the electrolytic solution: 98%, |
| | Aladdin Industrial Corporation |
| Diethyl carbonate (DEC) | Organic solvent used for the electrolytic solution: CP grade, |
| | 99.0%, Shanghai Ning Feng Chemical Reagent Co. |
| Coin cell | Casing; 2032 type; ShanXi LiZhiYuan Battery Material Co. |
| Nickel sponge | Thickness: 1 mm each layer. for each coin cell 4 layers was |
| | used; Changsha LiYuan New Material Co. |
| 3M tape | vinyl electrical tape, produced by 3M China Company; width |
| | of the tape: 17.5 mm. |

### Test Methods

### Acrylonitrile Content

The nitrogen content for determination of the acrylonitrile content was determined in the nitrile rubbers (1) to DIN 53 625 according to Kjeldahl.

### Mooney Viscosity

The values of the Mooney viscosity (ML 1+4@100° C.) are determined in each case by means of a shearing disc viscometer to DIN 53523/3 or ASTM D 1646 at 100° C. The MSR (Mooney Stress Relaxation) is determined in each case by means of a shearing disc viscometer to ISO 289-4:2003(E) at 100° C.

### Particle Size Determination

The particle size of the powderous samples was determined using a laser diffuser. The samples were made using the Fraunhofer approximation, which the article size distribution with the refractive and absorption index “1” calculated, determined. The volume histogram resulted in D90 as output of the analysis. The D90 describes the diameter where ninety percent of the distribution has a smaller particle size and ten percent has a larger particle size.

### Blocking Tendency

The blocking tendency of the powders was subjected to visual assessment, and evaluated using the following criteria:
1=Sample does not block, and is free-flowing
2=Sample exhibits only slight blocking, and falls apart under low pressure
3=Sample exhibits slight blocking, sticks together, and can be broken apart with gentle pressure
4=Sample undergoes hard blocking, can be separated only with application of force, and fragments continue to stick together
5=Sample can not longer be separated into powderous particles

### Solubility

The samples were dissolved according to the following procedure, and their solubility evaluated using the succeeding criteria.

A 1 wt % sample of the sample is place in the given solvent and shaken at room temperature at 150 rpm using a IKA shaker KS 4000i control. After a given time the samples were subjected to visual assessment.
A=Sample is not dissolved
B=Sample starts to be dissolved, swollen particles and most of sample remaining undissolved
C=Sample starts to be dissolved, particles remaining undissolved
D=Most of sample is dissolved, small residuals or partial cloudiness
E=Sample is fully dissolved and do not show any residuals

### NMR

The microstructure and the termonomer content of the individual polymers are determined by means of 1H NMR (instrument: Bruker DPX400 with XWIN-NMR 3.1 software, measurement frequency 400 MHz, solvent CDCl₃).

### Method of Evaluating Peel Strength

The evaluation of the peel strength was performed according to ASTM D903. The cathode sheet was cut into test strips with a width of 25 mm and 175 mm length. 3M vinyl electrical tape was bonded onto the coated cathode active material surface of the cathode sheet. The peel test was carried out on the test strip through an Instron tensile machine peeling the tape in a 180° direction with 100 mm/min. The peel force was recorded during the test. The peel strength was calculated according to the following formula:

$$Peel strength [ N / m ] = \frac{Peel force [ Newtons ]}{Width [ 0.0175 m ]}$$

The average peel strength was calculated basing on the data among 50-200 mm displacement and the average of three measurements was taken as peel strength value.

### Method of Evaluating Discharging Specific Capacity

The produced secondary battery was charged at 0.2 C rate at 23° C. until the battery voltage reached 4.2 V. Subsequently after 20 minutes, at 23° C., a constant current discharge was performed at 0.2 C rate until the battery voltage reached 2.75 V. The coin cell secondary battery was charged and discharged thereafter in constant current mode (CC mode 0.2 C rate). Between every cycle, there the cell is rested for 5 min. The discharging specific capacity of the secondary battery was calculated as the average value between 2 and 5 cycles.

### Method of Evaluating Capacity Retention

The coin cell secondary battery was charged and discharged in constant current mode (CC mode 0.2 C rate) for 30 cycles. Capacity retention was determined as the ratio of the discharge specific capacity after 30 cycles over the discharge specific capacity after the second cycle in percent.

### Preparation of Fully Hydrogenated Acetoacetoxyalkyl Methacrylate Containing, Acrylonitrile Butadiene Terpolymer C

The following materials were used as provided:
Monomer units acrylonitrile and acetoacetoxyethyl methacrylate from Sigma-Aldrich, 1,3-butadiene from INEOS.
Solution Fe(II)SO4: Premix solution contains 0.986 g Fe(II)SO4*7 H2O and 2.0 g Rongalit® C in 400 g water.
EDTA: as complexing agent from Sigma-Aldrich.
Fatty acid: CAS 67701-08-8, emulsifier for polymerisation.
Rosin acid: Na salt of disproportionated rosin acid CAS 61790-51-0.
t-DDM: Molecular weight regulator from Arlanxeo Deutschland GmbH.
Trigonox® NT50, p-menthane hydroperoxide from Akzo-Degussa. Initiator for emulsion polymerisation.
Diethylhydroxylamine: polymerisation terminator, CAS 3710-84-7.
Antioxidant: equal mix of Irganox® 1520-2-Methyl-4,6-bis(octylsulfanylmethyl)phenol (BASF AG, Germany), Irganox® 1076-n-Octadecyl-β-(4-hydroxy-3,5-di-tert-butyl-phenyl)-propionate (BASF AG, Germany) and Wingstay® L-Poly(dicyclopentadiene-co-p-cresol) (Omnova, Italy).
Dry monochlorobenzene (MCB) from VWR.
Wilkinson catalyst from Materia Inc. and triphenylphosphine from VWR as hydrogenation catalyst.

Acetoacetoxyalkyl group-containing fully hydrogenated acrylonitrile butadiene terpolymer C, used as base polymer for the preparation of powderous rubbers in the example series which follow, was produced according to the description below, with all feedstocks stated in parts by weight based on 100 parts by weight of the monomer mixture in Table 1.

Acrylonitrile butadiene terpolymer C was produced batchwise in a 5 L autoclave with stirrer system. In the autoclave batch, 1.25 kg of the monomer mixture and a total amount of water of 2.1 kg was used, as was EDTA in an equimolar amount based on the Fe(II). 1.9 kg of this amount of water were initially charged with the emulsifier in the autoclave and purged with a nitrogen stream. Thereafter, the destabilized monomers and t-DDM (tert-dodecylmercaptane) as molecular weight regulator were added and the reactor was closed. After the reactor contents had been brought to temperature, the polymerizations was started by the addition of the Fe(II)SO₄ premix solution and of para-menthane hydroperoxide (Trigonox® NT50). The course of the polymerization was monitored by gravimetric determinations of conversion. On attainment of the conversions reported in Table 1, the polymerization was stopped by adding an aqueous solution of diethylhydroxylamine. Unconverted monomers and other volatile constituents were removed by means of steam distillation.

A 50% dispersion of the antixoxidant was mixed with a dispersion of the acrylonitrile butadiene terpolymer and adjusted to solid content of 17.5% by weight. Afterwards the resulting dispersion comprising the acetoacetoxyalkyl group-containing acrylonitrile butadiene terpolymer and the antioxidant have been added slowly and under vigorous stirring to an aqueous solution of calcium chloride having a concentration of 0.34% by weight at a constant pH of 6 at 60° C. The stabilized coagulated terpolymer, is washed at pH 6 and a temperature of 60° C. with water and dried for 16 hours in a vacuum oven.

After hydrogenation with a standard Ru-based hydrogenation catalyst in chlorobenzene according Table 1, the hydrogenated acetoacetoxyalkyl group-containing acrylonitrile butadiene terpolymer C obtained had the properties reported in Table 2. The spectrum of acetoacetoxyalkyl acrylate group-containing acrylonitrile butadiene rubber terpolymer before, during and after the hydrogenation reaction was recorded on a Perkin Elmer spectrum 100 FT-IR spectrometer. The solution of the acrylonitrile butadiene rubber terpolymer in chlorobenzene was cast onto a KBr disk and dried to form a film for the test. The hydrogenation conversion is determined by the FT-IR analysis according to the ASTM D 5670-95 method.

TABLE 1
Preparation of acetoacetoxyalkyl group-containing hydrogenated
acrylonitrile butadiene rubber copolymers C

| | XBRS303-5/6 |
|---|---|
| Copolymer | C |
| Butadiene [phm] | 43.2 |
| Acrylonitrile [phm] | 51.8 |
| Acetoacetoxyalkyl methacrylate (AAEM) [phm] | 5.0 |
| Water [phm] | 200 |
| Fatty acid [phm] | 2.16 |
| Rosin acid [phm]¹ | 0.25 |
| pH | 10.5 ± 0.5 |
| t-DDM [phm] | 0.8 |
| Trigonox ® NT 50 [phm] | 0.02 |
| Premix solution Fe(II)SO₄¹ [phm] | 0.02 |
| Diethylhydroxylamine [phm] | 0.2 |
| Polymerization temperature [° C.] | 12.5 ± 0.5 |
| Conversion [%] | 75 |
| Hydrogenation | Yes |
| Hydrogenation catalyst | 0.065 |

¹Premix solution contains 0.986 g Fe(II)SO₄ * 7 H₂O and 2.0 g Rongalit ® C at 400 g water

TABLE 2
Monomer unit content, % of residual double bonds and Mooney
viscosity of polymer C made according to Table 1

| Polymer | C |
|---|---|
| Acrylonitrile (wt.-%) | 44.6 |
| 1,3-butadiene (wt.-%) | 50.4 |
| Acetoacetoxyethyl | 5.0 |
| methacrylate (wt.-%) | |
| Residual double-bonds (%) | 5.2 |

### Preparation of Powderous Rubbers

The rubbers were mixed intimately with the amount of separating agent specified in each case in a beaker and were added gradually to a ZM 200 ultracentrifuge mill (Retsch®). The mill was equipped with an annular sieve of average mesh size 0.25 mm and was operated at a speed of 10 000 rpm. During grinding the mill is cooled with liquid Nitrogen. After grinding, the powders were removed from the grinding chamber by means of a cyclone and collected. All resulting powders are dried for 24 h at 55° C. The obtained powders were evaluated.

The pulverulent mixtures according to the invention using Lithium stearate as separating agent have an average particle diameter D(90) preferably in the range from 0.05 mm to 3 mm, more preferably in the range from 0.08 mm to 2 mm, in particular in the range from 0.10 mm to 1.75 mm and especially preferably in the range from 0.10 mm to 1.5 mm.

The results of the prepared innovative and comparative polymer powders are shown in Tables 3-6

TABLE 3
Composition and properties of innovative polymer powders 1-6

| Sample | 1 | 2 | 3 | 4 | 5 | 6 |
|---|---|---|---|---|---|---|
| Polymer | A | B | C | D | | F |
| Separating | Lithium | Lithium | Lithium | Lithium | Lithium | Lithium |
| agent | stearate | stearate | stearate | stearate | stearate | stearate |
| Amount | 8 | 8 | 8 | 10 | 10 | 8 |
| separating | | | | | | |
| agent [%] | | | | | | |
| Li- | Yes | Yes | Yes | Yes | yes | Yes |
| containing | | | | | | |
| separating | | | | | | |
| agent | | | | | | |
| D90 [μm] | 249 | 552 | 560 | 456 | 295 | 713 |
| Blocking | 1 | 1 | 1 | 1 | 1 | 1 |
| tendency | | | | | | |

TABLE 4
Composition and properties of innovative polymer powders 7-11

| Sample | 7 | 8 | 9 | 10 | 11 |
|---|---|---|---|---|---|
| Polymer | G | H | I | G | K |
| Separating | Lithium | Lithium | Lithium | Lithium | Lithium |
| agent | stearate | stearate | stearate | stearate | stearate |
| Amount | 8 | 8 | 8 | 8 | 13 |
| separating | | | | | |
| agent [%] | | | | | |
| Li-containing | Yes | Yes | Yes | Yes | Yes |
| separating | | | | | |
| agent | | | | | |
| D90 | 306 | 492 | 834 | 485 | 548 |
| Blocking | 1 | 1 | 1 | 1-2 | 1-2 |
| tendency | | | | | |

TABLE 5
Composition and properties of comparative polymer
powders using alternative separatings agent 12-17

| Sample | 12 | 13 | 14 | 15 | 16 | 17 |
|---|---|---|---|---|---|---|
| Polymer | A | A | A | A | A | A |
| Separating | Lithium | Lithium | Calcium | Calcium | Silica | Aluminium |
| agent | carbonate | phosphate | stearate | carbonate | | oxide |
| Amount | 8 | 8 | 8 | 8 | 8 | 8 |
| separating | | | | | | |
| agent [%] | | | | | | |
| Li- | Yes | Yes | No | No | No | No |
| containing | | | | | | |
| separating | | | | | | |
| agent | | | | | | |
| D90 [μm] | np* | np* | np* | np* | 343 | 383 |
| Blocking | 4-5 | 4-5 | 3-4 | 5 | 1 | 2 |
| tendency | | | | | | |

np*: not possible to determine due to blocking of sample

TABLE 5
Composition and properties of comparative polymer
powders using alternative separatings agent 18-23

| Sample | 18 | 19 | 20 | 21 | 22 | 23 |
|---|---|---|---|---|---|---|
| Polymer | B | B | F | F | I | I |
| Separating | Lithium | Lithium | Lithium | Lithium | Lithium | Lithium |
| agent | carbonate | phosphate | carbonate | phosphate | carbonate | phosphate |
| Amount | 8 | 8 | 8 | 8 | 8 | 8 |
| separating | | | | | | |
| agent [%] | | | | | | |
| Li- | Yes | Yes | Yes | Yes | Yes | Yes |
| containing | | | | | | |
| separating | | | | | | |
| agent | | | | | | |
| D90 [μm] | np* | np* | np* | np* | np* | np* |
| Blocking | 5 | 5 | 5 | 5 | 5 | 5 |
| tendency | | | | | | |

np*: not possible to determine due to blocking of sample

TABLE 6
Composition and properties of comparative polymer
powders using alternative separatings agent 24-29

| Sample | 24 | 25 | 26 | 27 | 28 | 29 |
|---|---|---|---|---|---|---|
| Polymer | B | A | B | F | D | E |
| Separating | Silica | No | No | No | no | No |
| agent | | | | | | |
| Amount | 10 | | | | | |
| separating | | | | | | |
| agent [%] | | | | | | |
| Li- | No | | | | | |
| containing | | | | | | |
| separating | | | | | | |
| agent | | | | | | |
| D90 [μm] | 822 | | | | | |
| Blocking | 1 | 5** | 5** | 5** | 5** | 5** |
| tendency | | | | | | |

np*: not possible to determine due to blocking of sample;
**solid piece of rubber, which can not be separated into powderous particles

TABLE 7
Composition and properties of comparative polymer 30-32

| Sample | 30 | 31 | 32 |
|---|---|---|---|
| Polymer | I | G | K |
| Separating | No | No | No |
| agent | | | |
| Amount | | | |
| separating | | | |
| agent [%] | | | |
| Li- | | | |
| containing | | | |
| separating | | | |
| agent | | | |
| D90 [μm] | 5** | 5** | 5** |
| Blocking | | | |
| tendency | | | |

**solid piece of rubber, which can not be separated into powderous particles

It can be noticed when using Lithium stearate as antidusting agent, free flowing powders can be easily obtained. This is true for several kinds of elastomers. Compared to other free flowing powders, sample 16 (Levapren® 900 with silica as antidusting agent) needs higher amounts of antidusting agents as sample 1 (Levapren® 900 with Lithium stearate) and did resulted even in a powder having a larger particle size than the innovative powder. Same is true when using Therban® XT as base polymer, a lower particle size of the powder can be obtained even with less antidusting agent.

Different powderous inventive samples and the respective base polymers were dissolved in NMP and their solubility was evaluated after 90 min. It can be noticed that all inventive powderous samples dissolve faster than the base polymer, leading to an improvement in battery cell productivity.

TABLE 8
Solubility tests of comparative polymers 25, 26, 28, 29, 31, 32

| Sample | 25 | 26 | 28 | 29 | 31 | 32 |
|---|---|---|---|---|---|---|
| Polymer | A | B | D | E | G | K |
| Solvent | NMP | NMP | NMP | NMP | NMP | NMP |
| Solubility | B | B | B | B | B | A |
| rating [90 | | | | | | |
| min] | | | | | | |

TABLE 9
Solubility tests of inventive polymer powders 1, 2, 4, 5, 10, 11

| Sample | 1 | 2 | 4 | 5 | 10 | 11 |
|---|---|---|---|---|---|---|
| Polymer | A | B | D | E | G | K |
| Solvent | NMP | NMP | NMP | NMP | NMP | NMP |
| Separating | Lithium | Lithium | Lithium | Lithium | Lithium | Lithium |
| agent | stearate | stearate | stearate | stearate | stearate | stearate |
| Solubility | D-E | C-D | D-E | D-E | C | D-E |
| rating [90 | | | | | | |
| min] | | | | | | |

### General Method of Coin Cell Fabrication

Step (1)—Dissolution: A certain amount of the polymer is dissolved in the solvent (NMP) in a shaker overnight at room temperature to form a binder solution (5 wt.-%).

Step (2)—Cathode slurry composition preparation: The binder solution from step 1 is mixed with the active material (NMC111) and the conductive material (conductive carbon black Super P) in a planetary ball mill (milling conditions: 28 Hz, 6 minutes, room temperature) to obtain the cathode slurry composition.

| Component | Weight [g] |
|---|---|
| Binder solution in NMP, 5 wt.-% = | 3.00 |
| 2.85 g NMP + 0.15 g copolymer | |
| Conductive carbon black (Super P) | 0.15 |
| Active material (NMC) | 1.20 |

Weight ratio: NMC/polymer/NMP/Super P=80/10/190/10 (Polymer concentration in NMP=5 wt.-%)

Step (3)—Production of the cathode disc: The cathode slurry composition was applied with a bar coater onto a current collector (aluminum foil) using 2.8 mm/s coating speed to form a cathode sheet. The coater slit gap of the coating machine was adjusted to 150 μm to obtain a pre-determined coating thickness.

Step (4)—Drying: The cathode sheet was dried in an oven at 80° C. for 120 minutes to remove NMP and moisture. After drying the cathode sheet was calendered to adjust the areal density (weight: 12-19 mg/disc; disc area: 201 mm²; density: 60-95 g/m²). From the calandered cathode sheet a cathode disc (ø 16 mm) was punched using a machine from ShenZhen PengXiang YunDa Machinery Technology Co., Model: PX—CP-S2. The punch edge was sharp without burr.

Step (5)—Assembly of the lithium-ion secondary battery: Assembly and pressing of the lithium-ion secondary battery is carried out in a glove box. The assembly comprises the coin cell casing top (2032 type; negative side), the nickel sponge, the lithium disc (as anode), the porous separator (Celgard 2340), the cathode disc and the casing bottom (positive side). All parts were assembled layer-by-layer. The electrolyte solution was dropped in during the assembly step in order to completely fill the free volume of the coin cell. Finally, the coin cell case was pressed by the press machine in the glovebox. An open-circuit voltage test was performed to check, whether short-circuit took place or not.

TABLE 10
Determination of the peel strength of the cathode sheet of the lithium-
ion battery comparative examples 1 to 3 and inventive example 4

| | | | Comparative | |
|---|---|---|---|---|
| | Comparative | Comparative | example 3 | Inventive |
| | example 1 | example 2 | Krynar ® | example 4 |
| Copolymer | Therban ® XT | Sample 24 | HSV 900 | Sample 2 |
| Peel | 359 | 407 | 146 | 350 |
| strength [N/m] | | | | |

In comparison to comparative example 3 using PVDF as cathode binder, inventive example 4 show higher peel strength. Using powderous polymers as cathode binders result in still high peel strengths of the electrode sheets compared to comparative examples 1 and 2.

TABLE 11
Determination of the discharging specific capacity
and the capacity retention of the lithium-ion battery
comparative example 1-2 and inventive example 4

| | Comparative | Comparative | Inventive |
|---|---|---|---|
| | example 1 | example 2 | example 4 |
| Copolymer | Therban XT | Sample 24 | Sample 2 |
| Discharging specific | 131 | 124 | 133 |
| capacity [mAh/g] | | | |
| Capacity retention | 63 | 77 | 84 |
| after 100 cycles | | | |

The results in Table 10 to 11 show that the use of free-flowing powderous rubbers with Lithium stearate can be used as binder for batteries, leading to higher capacity retentions compared to the base polymer or polymer powders using different kinds of antidusting agents. In comparison to the base polymers they can be as well faster dissolved, which is advantageous for battery cell productions.

It should be appreciated that the various aspects and embodiments of the detailed description as disclosed herein are illustrative of the specific ways to make and use the invention and do not limit the scope of invention when taken into consideration with the claims and the detailed description. It will also be appreciated that features from different aspects and embodiments of the invention may be combined with features from different aspects and embodiments of the invention.

1. A pulverulent mixture of elastomers comprising
(1) (a) an ethylene-vinyl acetate copolymer containing repeat units
of an ethylene monomer, and
of a vinyl acetate monomer in an amount of at least 70% by weight and based on a total weight of the ethylene-vinyl acetate copolymer;
or
(b) a nitrile rubber copolymer which is optionally carboxylated and contains repeat units
of an α,β-unsaturated nitrile monomer selected from the group consisting of acrylonitrile, methacrylonitrile, ethacrylonitrile and mixtures thereof, in each case in an amount of at least 15% by weight and based on a total weight of the nitrile rubber copolymer, and
of a conjugated diene monomer which is optionally fully or partially hydrogenated and is selected from the group consisting of 1,2-butadiene, 1,3-butadiene, isoprene, 2,3-dimethylbutadiene, piperylene and mixtures thereof;
and
(2) an antidusting agent comprising lithium stearate.

2. The pulverulent mixture according to claim 1 having a particle size distribution D90 of at least 100 μm, as determined by using a laser diffuser.

3. The pulverulent mixture according to claim 1, wherein the nitrile rubber copolymer (b) is a carboxylated nitrile rubber (XNBR) which is optionally fully or partially hydrogenated.

4. The pulverulent mixture according to claim 1, wherein the ethylene-vinyl acetate copolymer (a) and/or the nitrile rubber copolymer (b) has a Mooney viscosity (ML(1+4) 100° C.) of ≥25 Mooney units (MU), determined by means of a shearing disc viscometer to DIN 53523/3 or ASTM D 1646 at 100° C.

5. The pulverulent mixture according to claim 1, further comprising an epoxy group-containing fluorine-free copolymer comprising repeating units derived from one or more epoxy group-containing monomer(s) of the general formula (1) 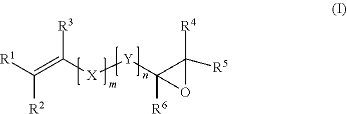
wherein
m is 0 or 1 and
X is O, O(CR₂)ₚ, (CR₂)ₚO, C(═O)O, C(═O)O(CR₂)ₚ, C(═O)NR, (CR₂)ₚ, N(R), N(R)(CR₂)ₚ, P(R), P(R)(CR₂)ₚ, P(═O)(R), P(═O)(R)(CR₂)ₚ, S, S(CR₂)ₚ, S(═O), S(═O)(CR₂)ₚ, S(═O)₂(CR₂)ₚ or S(═O)₂, wherein R in these radicals may have the same definitions as R¹-R⁶,
Y represents repeating units derived from one or more, mono- or polyunsaturated monomer(s), comprising conjugated or non-conjugated dienes, alkynes and vinyl compounds, or represents a structural element which derives from polymers comprising polyethers, more particularly polyalkylene glycol ethers and polyalkylene oxides, polysiloxanes, polyols, polycarbonates, polyurethanes, polyisocyanates, polysaccharides, polyesters and polyamides,
n and p are the same or different and are each in the range of 0 to 10 000, and
R, R¹, R², R³, R⁴, R⁵ and R⁶ are identical or different and are H, a linear or branched, saturated or mono- or polyunsaturated alkyl radical, a saturated or mono- or polyunsaturated carbo- or heterocyclyl radical, aryl, heteroaryl, arylalkyl, heteroarylalkyl, alkoxy, aryloxy, heteroaryloxy, amino, amido, carbamoyl, alkylthio, arylthio, sulphanyl, thiocarboxyl, sulphinyl, sulphono, sulphino, sulpheno, sulphonic acids, sulphamoyl, hydroxyimino, alkoxycarbonyl, F, Cl, Br, I, hydroxyl, phosphonato, phosphinato, silyl, silyloxy, nitrile, borates, selenates, carbonyl, carboxyl, oxycarbonyl, oxysulphonyl, oxo, thioxo, epoxy, cyanates, thiocyanates, isocyanates, thioisocyanates or isocyanides.

6. A cathode slurry composition comprising
the pulverulent mixture according to claim 1,
at least one cathode active material,
at least one conductive material, and
at least one solvent.

7. The cathode slurry composition according to claim 6, wherein the at least one cathode active material comprises a compound of the following Formula 1:
Li₁₊ₐNiₓCo_{y}Mn_{z}M_{w}O₂ [Formula 1]
wherein, M may be at least one selected from the group consisting of aluminum (Al), copper (Cu), iron (Fe), vanadium (V), chromium (Cr), titanium (Ti), zirconium (Zr), zinc (Zn), tantalum (Ta), niobium (Nb), magnesium (Mg), boron (B), tungsten (W), and molybdenum (Mo), and a, x, y, z, and w represent an atomic fraction of each independent element, wherein −0.55≤a≤0.5, 0<x≤1, 0<y≤1, 0≤z≤1, 0≤w≤1, and 0<x+y+z≤1 or lithium iron phosphates (LFP).

8. The cathode slurry composition according to claim 6, wherein the at least one conductive material is selected from the group consisting of carbon black, acetylene black, Ketjen black, channel black, furnace black, lamp black and summer black, natural and artificial graphite, expanded graphite, conductive fibers such as carbon fiber and metal fiber, one or more metal powders comprising carbon fluoride, aluminum and nickel powder, and carbon nanotube, graphene, graphene oxide and their mixtures.

9. The cathode slurry composition according to claim 6, wherein the at least one conductive material is present in an amount of 0.5 to 50% by weight based on a total solid weight of the cathode slurry composition.

10. The cathode slurry composition according to claim 6, wherein the at least one solvent comprises cyclic aliphatic hydrocarbons, aromatic hydrocarbons, ketones, chlorine based aliphatic hydrocarbons, esters, acylonitriles, ethers, alcohols, nitriles or amides.

11. A cathode comprising a current collector and a cathode active material layer, wherein the cathode active material layer comprises the pulverulent mixture according to claim 1 and at least one conductive material.

12. The cathode according to claim 11, wherein the current collector is selected from a group consisting of iron, copper, aluminum, nickel, sintered carbon, stainless steel, stainless steel treated with carbon, titanium, tantalum, gold, platinum, titanium or silver on the surface thereof; an aluminum-cadmium alloy, a non-conductive polymer treated with a conductive material on the surface thereof; a conductive polymer or a metal paste comprising metal powders of Ni, Al, Au, Ag, Pd, Cr, Ta, Cu or Ba.

13. A lithium-ion battery comprising at least one cell comprising an anode, a cathode according to claim 11, a separator, and an electrolytic solution based on a lithium salt and on an organic solvent.

14. A binder in an electrode composition for a cathode of a cell of a battery comprising the pulverulent mixture according to claim 1.

15. The cathode slurry composition according to claim 10, wherein the at least one solvent comprises at least one of methyl ethyl ketone, toluene and N-methylpyrrolidone.
